(19) United States
(12) Patent Application Publication
(10) Pub. No.: US 2025/0020413 A1
(43) Pub. Date: Jan. 16, 2025

(54) Boiling-Cooler Production Method and Boiling Cooler

(71) Applicant: Sumitomo Precision Products Co., Ltd., Amagasaki-shi (JP)

(72) Inventors: Akihiro TANABE, Amagasaki-shi (JP); Shota HANAFUSA, Amagasaki-shi (JP); Kenji ANDO, Amagasaki-shi (JP)

(21) Appl. No.: 18/899,330

(22) Filed: Sep. 27, 2024

Related U.S. Application Data
(63) Continuation of application No. PCT/JP2023/010745, filed on Mar. 17, 2023.

(30) Foreign Application Priority Data
Mar. 31, 2022 (JP) 2022-059362

(51) Int. Cl. F28D 15/02; B22F 10/28; B23P 15/26; B33Y 10/00; B33Y 40/20; B33Y 80/00

(52) U.S. Cl. CPC F28D 15/0266; B23P 15/26; B22F 10/28; B33Y 10/00; B33Y 40/20; B33Y 80/00

(57) ABSTRACT

A boiling-cooler production method according to the present invention is a method for producing a boiling cooler including a boiler for vaporizing a refrigerant by transferring heat from a heat source and a condenser for condensing the vaporized refrigerant and returning the condensed refrigerant to the boiler, the method including forming the condenser; and forming the boiler. The forming the boiler includes forming a boiling surface portion on a surface that is opposite to a mounting surface onto which the heat source is mounted, and is in contact with the refrigerant. The forming the boiling surface portion includes forming a plurality of protrusions that are aligned to each other and whose widths gradually increase from bases to ends of the protrusions.

### BACKGROUND OF THE INVENTION

### Field of the Invention

This invention relates to a method for producing a boiling cooler and a boiling cooler, in particular to a method for producing a boiling cooler and a boiling cooler including a boiler for boiling a refrigerant and a condenser for condensing the refrigerant and returning the condensed refrigerant to the boiler.

### Description of the Background Art

Boiling coolers including a boiler for boiling a refrigerant and a condenser for condensing the refrigerant and returning the condensed refrigerant to the boiler are known.

Some thermo-siphon type coolers, which is one type of the boiling coolers, includes a plurality of fins formed on the boiler. However, improvement of boiling heat transfer performance of the boiler by using the plurality of fins approaches its limit. As technology marches on, a boiling cooler including a boiler having higher boiling heat transfer performance is desired.

One or more aspects of the present invention are directed to provide a method for producing a boiling cooler and a boiling cooler including a boiler having high boiling heat transfer performance.

### SUMMARY OF THE INVENTION

The method for producing a boiling cooler according to an aspect of the present invention is a method for producing a boiling cooler including a boiler for vaporizing a refrigerant by transferring heat from a heat source and a condenser for condensing the vaporized refrigerant and returning the condensed refrigerant to the boiler, the method including forming the condenser; and forming the boiler, wherein the forming the boiler includes forming a boiling surface portion on a surface that is opposite to a mounting surface onto which the heat source is mounted, and is in contact with the refrigerant, and the forming the boiling surface portion includes forming a plurality of protrusions that are aligned to each other and whose widths gradually increase from bases to ends of the protrusions.

A boiling cooler according to an aspect of the present invention includes a boiler for vaporizing a refrigerant by transferring heat from a heat source; and a condenser for condensing the vaporized refrigerant and returning the condensed refrigerant to the boiler, wherein the boiler includes a mounting surface onto which the heat source is mounted, and a boiling surface portion on a surface that is opposite to the mounting surface, and is in contact with the refrigerant, and the boiling surface portion includes a plurality of protrusions that are aligned to each other and whose widths gradually increase from bases to ends of the protrusions.

According to the present invention, it is possible to provide a method for producing a boiling cooler and a boiling cooler including a boiler having high boiling heat transfer performance.

### BRIEF DESCRIPTION OF THE DRAWINGS

FIG. 1 is a perspective view showing a boiling cooler according to a first embodiment.

FIG. 2 is an exploded perspective view (1) showing the boiling cooler according to the first embodiment.

FIG. 3 is an exploded perspective view (2) showing the boiling cooler according to the first embodiment.

FIG. 4 is a perspective view showing a boiling surface portion according to a first example of the first embodiment.

FIG. 5 is a sectional view showing a part of the boiling surface portion according to the first example of the first embodiment.

FIG. 6 is a perspective view showing a boiling surface portion according to a second example of the first embodiment.

FIG. 7 is a sectional view showing a part of the boiling surface portion according to the second example of the first embodiment.

FIG. 8 is a perspective view showing a boiling surface portion according to a third example of the first embodiment.

FIG. 9 is a sectional view showing a part of the boiling surface portion according to the third example of the first embodiment.

FIG. 10 is a perspective view showing a boiling surface portion according to a fourth example of the first embodiment.

FIG. 11 is a sectional view showing a part of the boiling surface portion according to the fourth example of the first embodiment.

FIG. 12 is a perspective view showing a boiling surface portion according to a fifth example of the first embodiment.

FIG. 13 is a sectional view showing a part of the boiling surface portion according to the fifth example of the first embodiment.

FIG. 14 is a view illustrating mounting of a mount to a condenser in the boiling cooler according to the first embodiment.

FIG. 15 is a view illustrating mounting of a heat source to the mount in the boiling cooler according to the first embodiment.

FIG. 16 is a perspective view showing the boiling cooler with the heat source being mounted according to the first embodiment.

FIG. 17 is an exploded perspective view showing a boiling cooler according to a first modified example of the first embodiment.

FIG. 18 is an exploded perspective view showing a boiling cooler according to a second modified example of the first embodiment.

FIG. 19 is a perspective view showing a boiling cooler according to a second embodiment.

FIG. 20 is an exploded perspective view (1) showing a boiler in the boiling cooler according to the second embodiment.

FIG. 21 is an exploded perspective view (2) showing a boiler in the boiling cooler according to the second embodiment.

FIG. 22 is a view illustrating mounting of a mount to a vaporizer main body in the boiling cooler according to the second embodiment.

FIG. 23 is a view illustrating mounting of a condenser to the vaporizer in the boiling cooler according to the second embodiment.

FIG. 24 is a perspective view showing the boiling cooler with the heat source being mounted according to the second embodiment.

FIG. 25 is an exploded perspective view showing a vaporizer in a boiling cooler according to a first modified example of the second embodiment.

FIG. 26 is an exploded perspective view showing a vaporizer in a boiling cooler according to a second modified example of the second embodiment.

FIG. 27 is a graph showing measured boiling heat transfer performances of boiling surface portions according to an example 1 and a comparative example.

FIG. 28 is a graph showing measured boiling heat transfer performances of boiling surface portions according to an example 2 and a comparative example.

FIG. 29 is a graph showing measured boiling heat transfer performances of boiling surface portions according to an example 3 and a comparative example.

FIG. 30 is a graph showing measured boiling heat transfer performances of boiling surface portions according to an example 4 and a comparative example.

FIG. 31 is a graph showing measured boiling heat transfer performances of the boiling surface portions according to the examples 1 to 4.

### DESCRIPTION OF THE PREFERRED EMBODIMENT

The following description will describe embodiments according to the present invention with reference to the drawings.

### First Embodiment

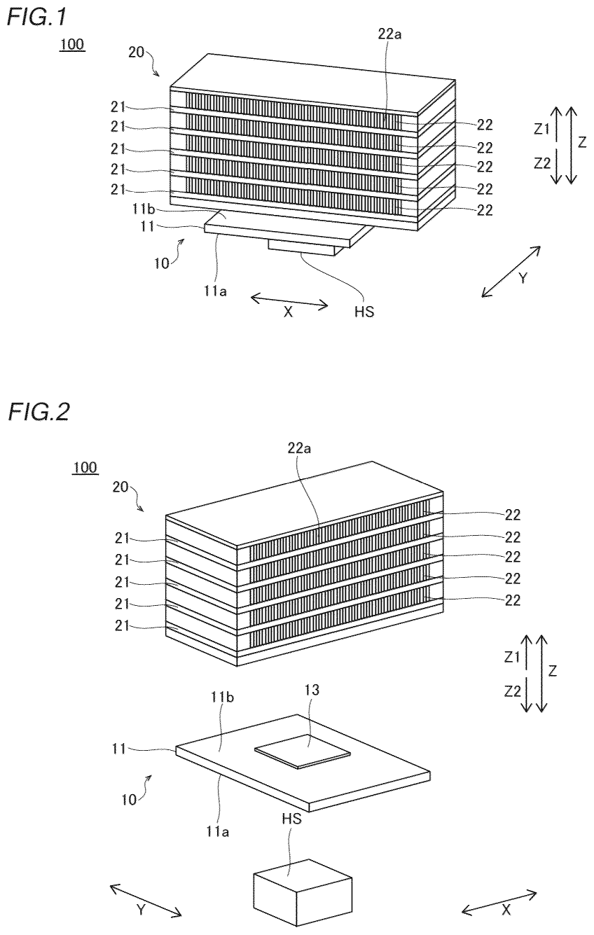

A configuration of a boiling cooler 100 (hereinafter, referred to as the cooler 100) according to a first embodiment is now described with reference to FIGS. 1 to 13. The cooler 100 is a cooler using a boiling cooling method, which absorbs heat from a heat source HS and dissipates the heat to the outside by using phase change (latent heat) in vaporization and condensation of a refrigerant. The heat source HS is, for example, a CPU (central processing unit). The heat source HS is not limited to any particular device. The refrigerant is, for example, fluorocarbons, hydrocarbons, or water. The refrigerant is not limited to any particular refrigerant.

Two directions substantially perpendicular to each other in a horizontal plane are defined as X and Y directions. An upward/downward direction substantially perpendicular to the horizontal plane (X-Y plane) is referred to as a Z direction. Here, the Z direction is parallel to a direction of gravity, and the gravity is applied in the downward direction.

As shown in FIGS. 1 to 3, the cooler 100 includes a boiler 10 and a condenser 20. The boiler 10 boils the refrigerant by transferring heat from the heat source HS. The condenser 20 condenses the refrigerant boiled by the boiler 10 and returns the boiled refrigerant to the boiler 10. In the first embodiment, the boiler 10 and the condenser 20 are formed as an integrated unit.

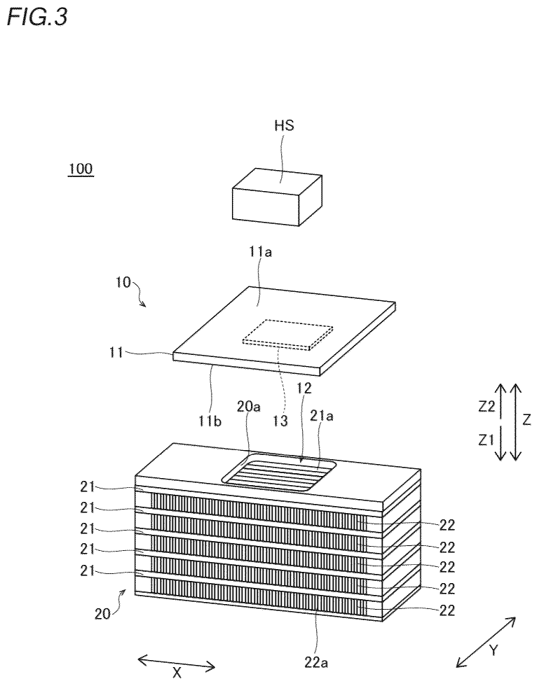

The boiler 10 includes a mount 11 and a reservoir 12 (see FIG. 3). The mount 11 is a flat-plate-shaped mount extending in horizontal directions. Also, a lower-side (Z2-direction side) surface of the mount 11 serves as a mounting surface 11a onto which the heat source HS is mounted. The mount 11 includes a boiling surface portion 13 on an upper-side (Z1-direction side) surface 11b opposite to the mounting surface 11a. The reservoir 12 accommodates the refrigerant that is in a liquid state. The reservoir 12 is defined by a cavity 20a formed in the condenser 20 and the surface 11b of the mount 11. The reservoir 12 is provided as a recessed part that is recessed in the downward direction (Z2 direction). The boiling surface portion 13 is in contact with the liquid refrigerant in the reservoir 12. The boiling surface portion 13 will be described in detail later.

The condenser 20 is configured as a plate-fin type heat exchanger. The condenser 20 includes refrigerant flow-paths 21 and external flow-paths 22. The refrigerant flow-paths 21 and the external flow-paths 22 are alternately arranged by interposing a divider between the refrigerant and external flow-paths. The refrigerant flow-paths 21 are flow paths through which the refrigerant flows. The refrigerant flow-paths 21 communicate with the reservoir 12 of the boiler 10. Specifically, the refrigerant flow-path 21 in a first stage (lowermost in the Z2 direction) communicates with the reservoir 12 of the boiler 10, and the refrigerant flow-paths 21 in second and higher stages communicate with each other inside the condenser. The refrigerant flows through all the refrigerant flow-paths 21. Corrugated fins 21a (see FIG. 3) are arranged to extend in the X direction inside the refrigerant flow-paths 21. The external flow-paths 22 are flow paths through which an external fluid flows. The external fluid is a fluid for cooling the refrigerant, for example, air. The external fluid is not limited to any particular fluid. The external flow-paths 22 are opened toward the outside. Corrugated fins 22a are arranged to extend in the Y direction in the external flow-paths 22.

When the heat from the heat source HS is transferred to the boiling surface portion 13 through the mount 11, the liquid refrigerant in the reservoir 12 is heated and boiled. The refrigerant that is vaporized by boiling moves into the refrigerant flow-paths 21, which communicate with the reservoir 12, and is cooled and condensed by the external fluid flowing through the external flow-paths 22. The refrigerant that is liquefied by condensation moves through the refrigerant flow-paths 21 and returns to the reservoir 12. Accordingly, the refrigerant enclosed in the cooler 100 is circulated between the boiler 10 and the condenser 20. As a result, the heat source HS is cooled.

### (Configuration of Boiling Surface Portion)

Here, in the first embodiment, the boiling surface portion 13 is at least partially formed by additive manufacturing. Specifically, the boiling surface portion 13 is at least partially formed by additive manufacturing using metal powder. More specifically, the boiling surface portion 13 is at least partially formed by powder bed fusion (PBF) as the additive manufacturing. The powder bed fusion is additive manufacturing that forms a three-dimensional additive-manufactured object (boiling surface portion 13, and the like) by repeatedly forming a layer of metal powder, and subjecting a formed part of the metal powder to sintering (fusion and hardening) by irradiating the formed part of the metal powder with high energy beam (laser light, electron beam, or the like). A surface of the boiling surface portion 13 formed by additive manufacturing has very small asperities resulting from sintering to which the metal powder is subjected by using a high-energy beam. Although the metal powder used in additive manufacturing (i.e., a material of the boiling surface portion 13) is not limited to any particular material, the metal powder can be aluminum (including an aluminum alloy), for example. In a case of aluminum, for example, a silicon-based aluminum alloy called Al-Si10-Mg can be used.

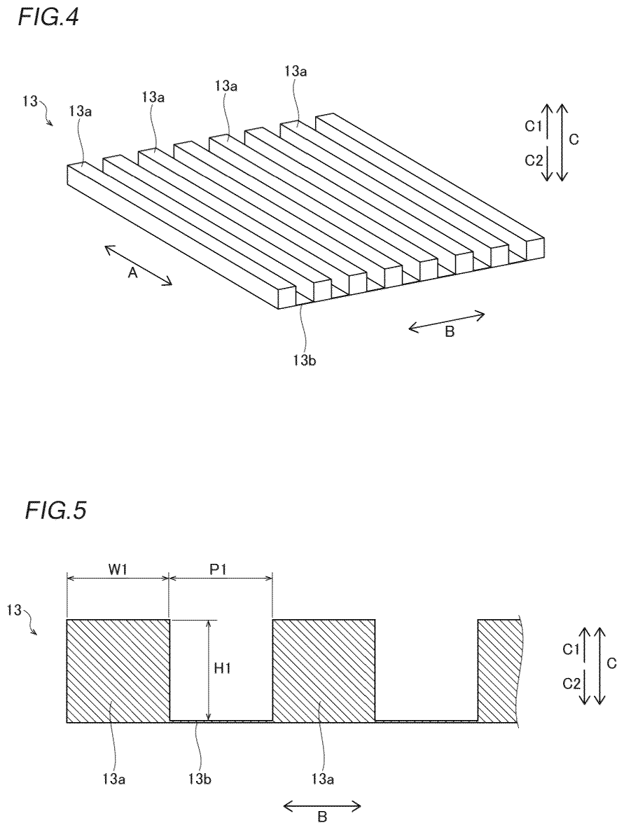

An exemplary configuration of the boiling surface portion 13 is described with reference to FIGS. 4 to 13. Two directions substantially perpendicular to each other in a plane substantially parallel to the boiling surface portion 13 are defined as A and B directions. A direction substantially perpendicular to the plane substantially parallel to the boiling surface portion 13 is defined as a C direction. In the first embodiment, the C direction agrees with the Z direction, C1 and C2 directions agree with the Z1 and Z2 directions, respectively. A part of the boiling surface portion 13 on a C2-directional side is joined to the surface 11b of the mount 11. The A direction and the B direction are examples of a “first direction” and a “second direction” in the claims, respectively.

### (First Example of Boiling Surface Portion)

A first example is shown in FIGS. 4 and 5. In the first example, the boiling surface portion 13 includes a plurality of linear protrusions 13a extending in the A direction and aligned to each other in the B direction. The plurality of linear protrusions 13a are arranged on a bottom plate 13b and protrude from the bottom plate 13b toward a C1-direction side. A plurality of grooves that extend in the A direction and are recessed toward a C2-direction side are formed by aligning the plurality of linear protrusions 13a, which extend in the A direction, to each other in the B direction, to be aligned to each other in the B direction between the linear protrusions 13a in the B direction. The linear protrusions 13a are rectangular-parallelepiped linear protrusions.

Each linear protrusion 13a has a width W1 and a height H1. The width W1 is a length of the linear protrusion 13a in the B direction. The height H1 is a length of the linear protrusion 13a in the C direction. The linear protrusions 13a are spaced at a pitch P1 away from each other to be aligned to each other in the B direction. The pitch P1 is a distance between the linear protrusions 13a adjacent to each other in the B direction. Also, the pitch P1 is a width of each groove in the B direction. Although the width W1, the height H1 and the pitch P1 are the same length in the example shown in FIGS. 4 and 5, they are not limited to any particular lengths. For example, the width W1, the height H1, and the pitch P1 are approximately 2 mm.

### (Second Example of Boiling Surface Portion)

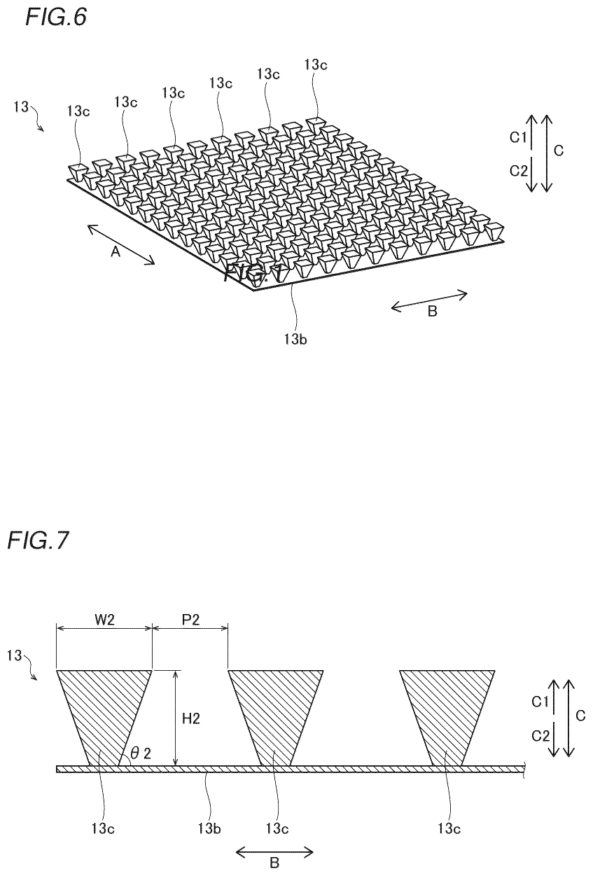

A second example is shown in FIGS. 6 and 7. In the second example, the boiling surface portion 13 includes a plurality of protrusions 13c that are aligned to each other and are formed in shapes whose widths gradually increase from bases (C2-direction side) to ends (C1-direction side) of the protrusions. Specifically, the boiling surface portion 13 includes the plurality of protrusions 13c aligned in a matrix shape in the A and B directions. The plurality of protrusions 13c are arranged on a bottom plate 13b and protrude from the bottom plate 13b toward the C1-direction side. Also, space is formed between the protrusions 13c to be filled with refrigerant by aligning the plurality of protrusions 13c in the matrix in the A and B directions. Each protrusion 13c has a regular quadrilateral prismoid whose width gradually increases from the C2-direction side to the C1-direction side. The protrusion 13c has an upper base part on the C2-direction side, a lower base part on the C1-direction side, and four tapered surfaces connecting the upper base to the lower base.

Each protrusion 13c has a width W2 and a height H2. The width W2 is a length of the lower base part of the protrusion 13c in the A and B directions. The height H2 is a length of the protrusion 13c in the C direction. Each tapered surface (each side surface) of the protrusion 13c is inclined an inclination angle θ2 with respect to an A-B plane. The protrusions 13c are spaced at a pitch P2 away from each other to be aligned to each other in the A and B directions. The pitch P2 is a distance between protrusions 13c adjacent to each other in the A or B direction. Although the width W2 and the height H2 are the same length in the example shown in FIGS. 6 and 7, they are not limited to any particular lengths. In the examples shown in FIGS. 6 and 7, the pitch P2 is smaller than the width W2. The plurality of protrusions 13c are spaced at the pitch P2 smaller than the width W2 of the protrusions 13c away from each other to be aligned to each other in the boiling surface portion 13 shown in FIGS. 6 and 7. Note that the pitch P2 is not limited to any particular length. For example, the width W2 and the height H2 are approximately 0.5 mm, and the pitch P2 and the inclination angle θ2 are approximately 0.4 mm and approximately about 70 degrees, respectively.

### (Third Example of Boiling Surface Portion)

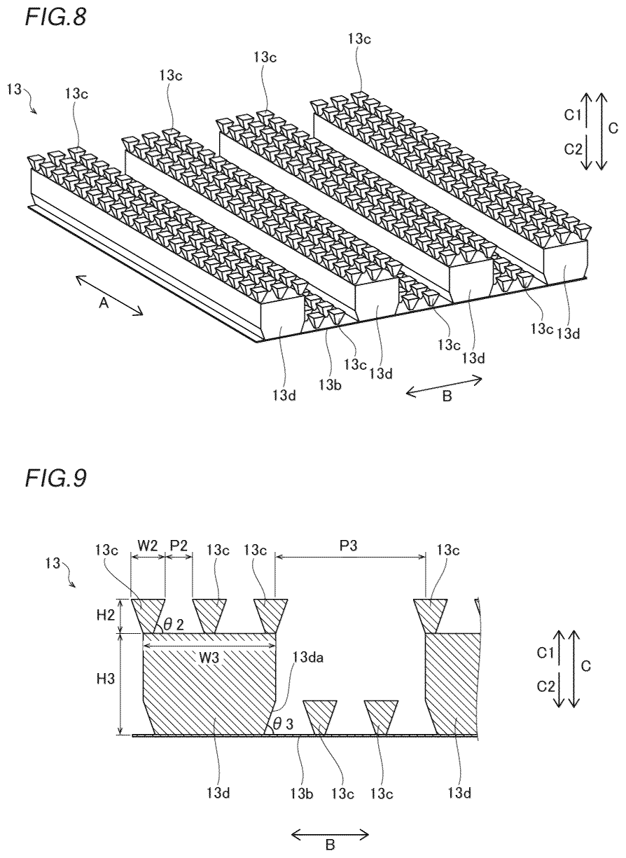

A third example is shown in FIGS. 8 and 9. In the third example, the boiling surface portion 13 includes a plurality of linear protrusions 13d that extend in the A direction and are aligned to each other in the B direction, and a plurality of protrusions 13c that are aligned to each other on the linear protrusions 13d and areas (i.e., grooves) between the linear protrusions 13d in the B direction. A plurality of linear protrusions 13d are arranged on a bottom plate 13b and protrude from the bottom plate 13b toward the C1-direction side. The plurality of grooves, which extend in the A direction and are recessed toward the C2-direction side, are formed between the linear protrusions 13d in the B direction by aligning the plurality of linear protrusions 13d, which extend in the A direction, to each other in the B direction to be aligned to each other in the B direction. Each linear protrusion 13d is a prism-shaped linear protrusion having tapered surfaces 13da in parts on the C2-direction side. The tapered surfaces 13da correspond to the protrusions 13c arranged in the grooves. Specifically, tapered surfaces 13da are arranged at positions facing the protrusion 13c that are arranged in the grooves and closest to the tapered surfaces 13da in the B direction, and, are inclined toward sides opposite to tapered surfaces of the protrusions 13c facing the tapered surfaces. The protrusions 13c are aligned in a matrix shape in the A and B directions both on the linear protrusions 13d and in the grooves (on the bottom plate 13b).

The linear protrusion 13d has a width W3 and a height H3. The width W3 is a length of the linear protrusion 13d in the B direction. The height H3 is a length of the linear protrusion 13d in the C direction. The linear protrusions 13d are aligned at a pitch P3 away from each other in the B direction. The pitch P3 is a distance between the linear protrusions 13d adjacent to each other in the B direction. Also, the pitch P3 is a width of each groove in the B direction. Although the height H3 is smaller than the width W3 and the pitch P3 is greater than the height H3 in the example shown in FIGS. 8 and 9, they are not limited to any particular lengths. Each tapered surface 13da of the linear protrusion 13d is inclined an inclination angle θ3 with respect to the A-B plane. The inclination angle θ3 is the same value as the inclination angle θ2. For example, the width W3, the height H3, the pitch P3 and the inclination angle θ3 are approximately 2.0 mm, approximately 1.5 mm, approximately 2.0 mm and approximately 70 degrees, respectively.

### (Fourth Example of Boiling Surface Portion)

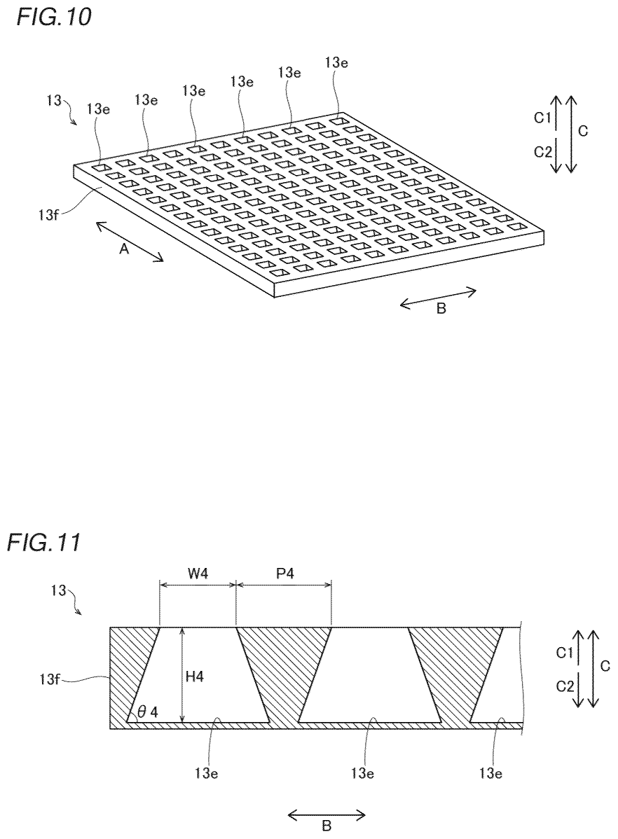

A fourth example is shown in FIGS. 10 and 11. In the fourth example, the boiling surface portion 13 includes a plurality of depressions 13e formed in shapes whose widths gradually increase from openings (C1-direction side) to bottoms (C2-direction side) of the depressions. Specifically, the boiling surface portion 13 includes the plurality of depressions 13e aligned in a matrix shape in the A and B directions. The plurality of depressions 13e are recessed toward the C2-direction side in a plate-shaped body 13f. Each depression 13e has a regular quadrilateral prismoid whose width gradually increases from the C1-direction side to the C2-direction side. The depression 13e has a bottom on the C2-direction side, an opening on the C1-direction side, and four tapered surfaces connecting the bottom to the opening. Such a shape of depression 13e is likely to produce bubbles (to serve as a starting point of boiling), and can improve boiling heat transfer performance. A cross-sectional shape of space between the protrusions 13c shown in FIGS. 6 to 9 is similar to that of the depression 13e.

Each depression 13e has a width W4 and a height H4. The width W4 is a length of the opening of the depression 13e in the A and B directions. The height H4 is a length of the depression 13e in the C direction. Each tapered surface (each side surface) of the depression 13e is inclined an inclination angle θ4 with respect to the A-B plane. The depressions 13e are aligned at a pitch P4 away from each other in the A and B directions. The pitch P4 is a distance between depressions 13e adjacent to each other in the A or B direction. Although the pitch P4 and the height H4 are the same length in the example shown in FIGS. 10 and 11, they are not limited to any particular lengths. Although the width W4 is smaller than the pitch P4 and the height H4 in the examples shown in FIGS. 10 and 11, it is not limited to any particular length. For example, the width W4, the height H4, the pitch P4 and the inclination angle θ4 are approximately 0.4 mm, approximately 0.5 mm, approximately 0.5 mm and approximately 70 degrees, respectively.

### (Fifth Example of Boiling Surface Portion)

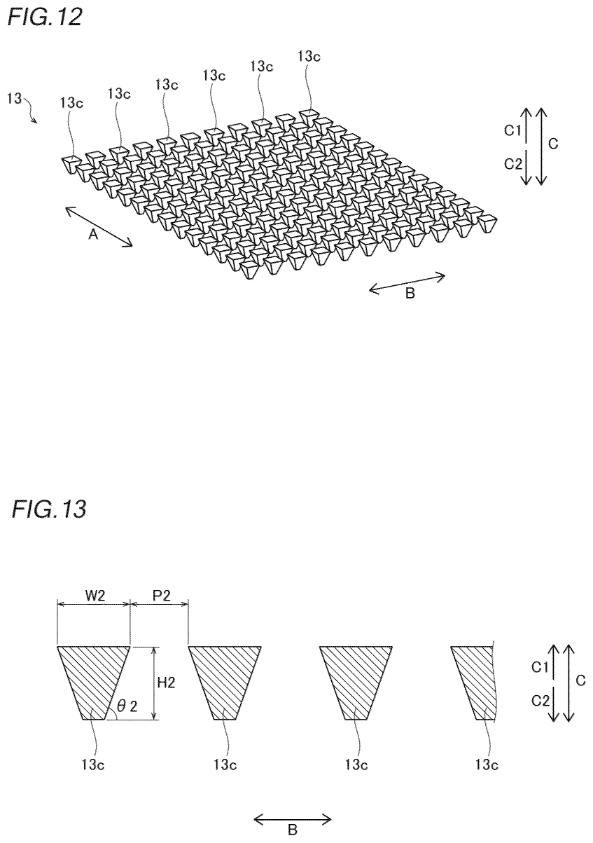

A fifth example is shown in FIGS. 12 and 13. The boiling surface portion 13 according to the fifth example is a boiling surface portion that is configured by removing the bottom plate 12b from the boiling surface portion 13 according to the second example. The boiling surface portion 13 according to the fifth example has the same configuration as the boiling surface portion 13 according to the second example except that the bottom plate 12b is not included. In other words, in the fifth example, the boiling surface portion 13 includes a plurality of protrusions 13c that are aligned to each other and are formed in shapes whose widths gradually increases from bases (C2-direction side) to ends (C1-direction side) of the protrusions. Specifically, the boiling surface portion 13 includes the plurality of protrusions 13c aligned in a matrix shape in the A and B directions. The protrusions 13c in the fifth example are directly joined to the surface 11b of the mount 11 by additive manufacturing.

### (Boiling-Cooler Production Method)

A method for producing the cooler 100 according to the first embodiment is now described with reference to FIGS. 14 to 16.

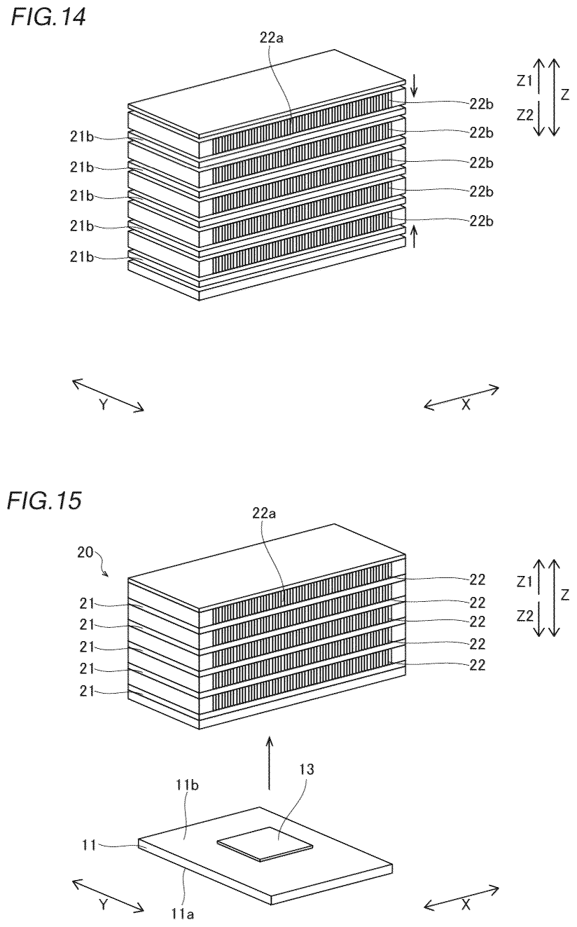

As shown in FIG. 14, the method for producing the cooler 100 includes forming the condenser 20. The forming the condenser 20 includes forming the condenser 20 by joining refrigerant flow-path elements 21b, which will serve as the refrigerant flow-paths 21, and external flow-path elements 22b, which will serve as the external flow-paths 22. As shown in FIG. 15, the method for producing the cooler 100 includes forming the boiler 10. The forming the boiler 10 includes forming the boiling surface portion 13, and joining the mount 11 to the condenser 20.

Here, in the first embodiment, the forming the boiling surface portion 13 is at least partially forming the boiling surface portion 13 by additive manufacturing. Specifically, the forming the boiling surface portion 13 includes at least partially forming the boiling surface portion 13 by additive manufacturing using metal powder. More specifically, the forming the boiling surface portion 13 includes at least partially forming the boiling surface portion 13 by powder bed fusion as additive manufacturing. In other words, the forming the boiling surface portion 13 includes the at least partially forming the boiling surface portion 13 by repeatedly forming a layer of metal powder, and subjecting a formed part of the metal powder to sintering by irradiating the formed part of the metal powder with high energy beam. In this forming, very small asperities resulting from sintering to which the metal powder is subjected by using a high-energy beam are formed on a surface of the boiling surface portion 13 as an additive-manufactured object.

Also, the forming the boiling surface portion 13 includes, in the case of the first example, the forming the linear protrusions 13a so as to extend the linear protrusions 13a in the A direction and to align the linear protrusions to each other in the B direction by using additive manufacturing. Also, the forming the boiling surface portion 13 includes, in the second, third and fifth examples, forming the plurality of protrusions 13c so as to align the plurality of protrusions 13c to each other and to be formed in shapes whose widths gradually increase from bases to ends of the protrusions by using additive manufacturing. Also, the forming the boiling surface portion 13 includes, in the case of the second and fifth examples, forming the protrusions 13c so as to align the plurality of protrusions 13c in a matrix shape in the A and B directions by using additive manufacturing. In the cases of the first, second and third examples, the bottom plate 13b is also formed by additive manufacturing, while in the fifth example, the bottom plate 13b is not formed. Also, the forming the boiling surface portion 13 includes, in the second and fifth examples, forming the plurality of protrusions 13c so as to space protrusions 13c at a pitch smaller than the width of each protrusion 13c away from each other by using additive manufacturing.

Also, the forming the boiling surface portion 13 includes, in the case of the third example, forming the linear protrusions 13d and the protrusions 13c so as to align the plurality of linear protrusions 13d, which extend in the A direction, to each other in the B direction, and to align the plurality of protrusions 13c to each other on the linear protrusions 13d and in areas between the linear protrusions 13d in the B direction by using additive manufacturing. Also, the forming the boiling surface portion 13 includes, in the case of the fourth example, forming an additive-manufactured object including a plurality of depressions 13e that are aligned to each other and are formed in shapes whose widths gradually increase from the openings to the bottoms of the depressions 13e by using additive manufacturing. In the first through fifth examples, the boiling surface portion 13 is entirely formed by using additive manufacturing.

In the first embodiment, the forming the boiling surface portion 13 includes forming the boiling surface portion 13 without blasting after additive manufacturing. In other words, the boiling surface portion 13 is used in the cooler 100 without its surface being subjected to surface treatment by using blasting after having been formed by using additive manufacturing. That is, the boiling surface portion 13 is used in the cooler 100 with the boiling surface portion having very small asperities resulting from sintering to which the metal powder is subjected by using a high-energy beam. Here, the boiling surface portion 13 may be subjected to heat treatment.

Also, the forming the boiling surface portion 13 includes joining the boiling surface portion 13 to the surface 11b of the mount 11 opposite to the mounting surface 11a onto which the heat source HS is mounted. Although the joining the boiling surface portion 13 to the surface 11b is not limited to any particular process, it includes joining the boiling surface portion 13 directly onto the surface 11b by using additive manufacturing, or joining the boiling surface portion 13 that has been formed as the additive-manufactured object by using additive manufacturing onto the surface 11b by using joining technique such as brazing, welding, or friction stir welding. In the case of the first to four examples, the boiling surface portion 13 can be joined onto the surface 11b by using joining technique. In the case of the fifth example, the boiling surface portion 13 is directly joined to the surface 11b by using additive manufacturing. After joining the boiling surface portion 13 to the surface 11b, joining the mount 11 to the condenser 20 is conducted.

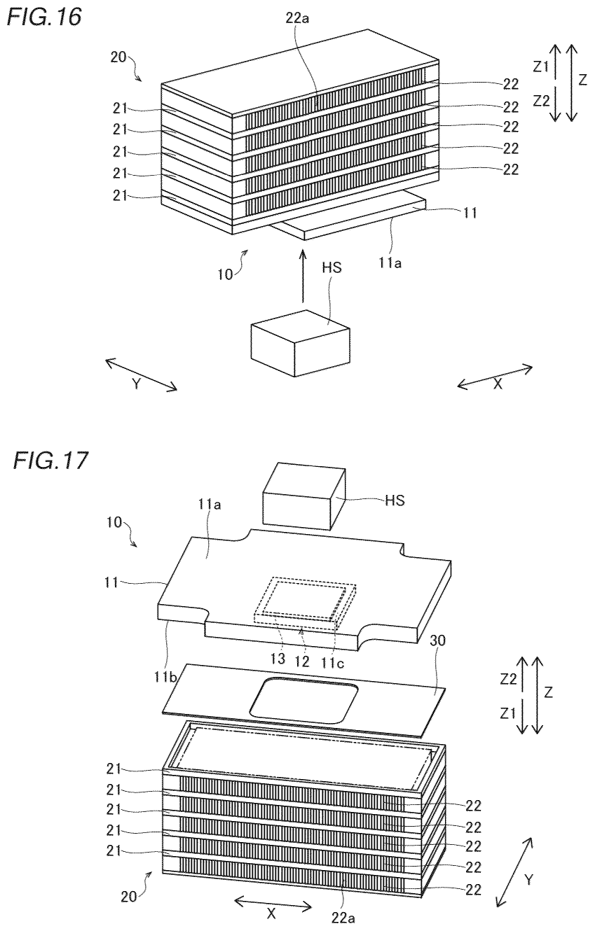

The joining the mount 11 onto the condenser 20 includes joining the mount 11 to the condenser 20 by welding. In this joining, four sides of the mount 11, which contact the condenser 20, are welded, for example. Also, the reservoir 12 is formed by joining the mount 11 onto the condenser 20 by welding. As a result, the boiler 10 is formed, and production of the cooler 100 is completed. After that, the heat source HS is mounted to the mounting surface 11a of the mount 11, as shown in FIG. 16.

### Advantages of First Embodiment

In the first embodiment, the following advantages are obtained.

The boiling surface portion 13 having high boiling heat transfer performance can be obtained by using additive manufacturing, and the boiling surface portion 13 can be obtained by simple processes using additive manufacturing without many separate processes. As a result, the boiling surface portion 13 having high boiling heat transfer performance can be obtained by simple processes.

Also, according to the first embodiment, the boiling surface portion 13 having very small asperities on its surface can be obtained by additive manufacturing using metal powder. Accordingly, since the very small asperities on the surface accelerate boiling, the boiling surface portion 13 having higher boiling heat transfer performance can be obtained.

Also, according to the first embodiment, since the boiling surface portion 13 having very small asperities on its surface can be easily obtained by powder bed fusion, the boiling surface portion 13 having higher boiling heat transfer performance can be easily obtained.

Also, according to the first embodiment, the boiling surface portion 13 having space that is defined between the protrusions 13c and can be filled with refrigerant can be obtained by forming the plurality of protrusions 13c so as to align the plurality of protrusions 13c to each other and be formed in shapes whose widths gradually increase from bases to ends of the protrusions by using additive manufacturing. Accordingly, when the refrigerant boils on the protrusions 13c or areas in proximity to protrusions, the refrigerant with which the space between the protrusions 13c is filled can be speedily supplied so that it is possible to prevent drying of the protrusions 13c and the areas in proximity to protrusions on which the refrigerant boils. As a result, since it is possible to avoid situations in which boiling is obstructed by drying of the protrusions 13c and the areas in proximity to protrusions, the boiling heat transfer performance of the boiling surface portion 13 can be improved. Although the plurality of protrusions 13c formed in shapes whose widths gradually increase from bases to ends of the protrusions are hardly formed by machining such as cutting, the plurality of protrusions can be easily formed by additive manufacturing.

Also, according to the first embodiment, the boiling surface portion 13 including the protrusions 13c aligned in balanced dispersion can be obtained by forming the plurality of protrusions 13c so as to align the plurality of protrusions 13c in a matrix shape in the A and B directions, which are substantially perpendicular to each other in a plane substantially parallel to the boiling surface portion 13, by using additive manufacturing. Accordingly, since the protrusions 13c are not unevenly positioned, improvement of the boiling heat transfer performance of the boiling surface portion 13 that is obtained by filling the areas between the protrusions 13c with the refrigerant can be evenly obtained at any position in the boiling surface portion 13.

Also, according to the first embodiment, since the linear protrusions 13d are formed so as to align the plurality of linear protrusions 13d, which extend in the A direction in a plane substantially parallel to the boiling surface portion 13, to each other in the B direction substantially perpendicular to the A direction in a plane substantially parallel to the boiling surface portion 13, and the protrusions 13c are formed so as to align the plurality of protrusions 13c to each other on the linear protrusions 13d and in areas between the linear protrusions 13d in the B direction by using additive manufacturing, it is possible to obtain the boiling surface portion 13 including a combination of the protrusions 13c, which are formed in shapes whose widths gradually increase from bases to ends of the protrusions, and the linear protrusions 13d. Consequently, improvement of the boiling heat transfer performance of the boiling surface portion 13 that is obtained by filling the areas between the protrusions 13c with the refrigerant can be obtained while increasing heat transfer areas by providing the linear protrusions 13d.

Also, according to the first embodiment, the plurality of protrusions 13c are spaced at the pitch P2 smaller than the width W2 of the protrusions 13c away from each other. Here, if the pitch P2 of the protrusions 13c is too large, the number of protrusions 13c that can be arranged in the boiling surface portion 13 decreases so that the boiling heat transfer performance of the boiling surface portion 13 is reduced. To address this, the configuration can prevent the pitch P2 of the protrusions 13c from becoming too large, and as a result it is possible to prevent the number of protrusions 13c that can be arranged in the boiling surface portion 13 from decreasing too much. Consequently, the boiling heat transfer performance of the boiling surface portion 13 can be appropriately set.

On one hand, according to the first embodiment, in the case in which the boiling surface portion 13 including the plurality of linear protrusions 13a is obtained, the boiling surface portion 13 can have a simple shape. On the other hand, in the case in which the boiling surface portion 13 having the plurality of depressions 13e is obtained, the boiling surface portion is formed in shapes including the depressions 13e whose widths gradually increase from openings in which bubbles are likely to be produced by boiling to bottoms of the depressions, and as a result it is possible to improve the boiling heat transfer performance of the boiling surface portion 13.

Also, according to the first embodiment, since the boiling surface portion 13 is formed without blasting after additive manufacturing, it is possible to prevent removal of very small asperities on the surface of the boiling surface portion 13 by blasting, and as a result the boiling surface portion 13 having high boiling heat transfer performance can be obtained. Also, processes for producing the boiling cooler 100 can be simplified as compared with a case in which blasting is conducted after additive manufacturing.

### First Modified Example of First Embodiment

A cooler according to a first modified example of the first embodiment is now described with reference to FIG. 17. In the first modified example, the mount 11 is joined to the condenser 20 by brazing.

As shown in FIG. 17, the joining the mount 11 onto the condenser 20 includes joining the mount 11 to the condenser 20 by brazing. In this joining, a brazing sheet 30 including a core material and a brazing material on both sides of the core material is arranged between the condenser 20 and the mount 11. The mount 11 is brazed onto the condenser 20 by using the brazing sheet 30. In the example shown in FIG. 17, a recessed part 11c is provided in the mount 11 instead of the cavity 20a in the first embodiment. When the mount 11 is brazed onto the condenser 20, the recessed part 11c forms the reservoir 12. As a result, the boiler 10 is formed, and production of the cooler 100 is completed. After that, the heat source HS is mounted to the mounting surface 11a of the mount 11.

### Second Modified Example of First Embodiment

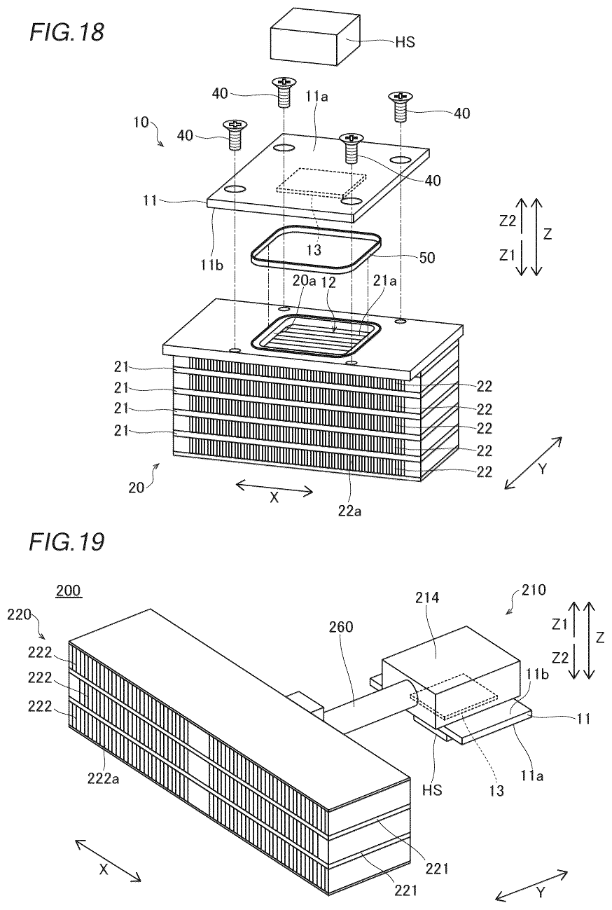

A cooler according to a second modified example of the first embodiment is now described with reference to FIG. 18. In the second modified example, the mount 11 is joined to the condenser 20 by screwing.

As shown in FIG. 18, the joining the mount 11 onto the condenser 20 includes joining the mount 11 to the condenser 20 by screwing. In this case, the mount 11 has insertion holes for receiving screws 40, and the condenser 20 has internally threaded holes with which the screws 40 threadedly engage. Also, a seal 50 such as an O-ring is arranged between the condenser 20 and the mount 11. The mount 11 is fixed onto the condenser 20 by screwing the screws 40 with the seal 50 being interposed between the condenser and the mount. As a result, the reservoir 12 is formed so that the boiler 10 is formed, and production of the cooler 100 is completed. Also, even in the case of screwing, the seal 50 can seal the refrigerant in the reservoir 12. After that, the heat source HS is mounted to the mounting surface 11a of the mount 11.

### Second Embodiment

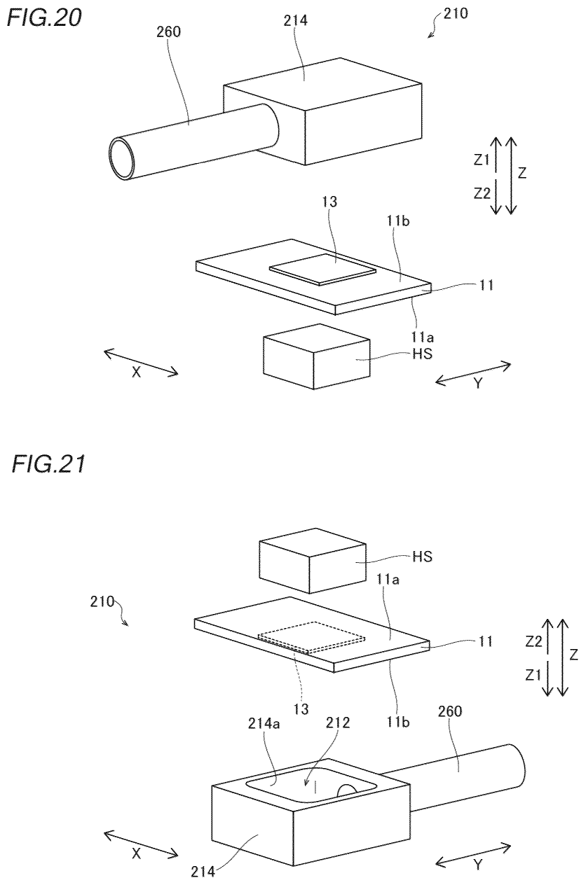

A configuration of a boiling cooler 200 (hereinafter, referred to as cooler 200) according to a second embodiment of the present invention is now described with reference to FIGS. 19 to 21. In the second embodiment, the boiler 210 and the condenser 220 are separated. Hereinafter, the same components as those of the first embodiment are denoted by the same reference numerals, and their description is occasionally omitted.

As shown in FIGS. 19 to 21, the cooler 200 includes a boiler 210, a condenser 220 and a connector 260. The boiler 210 boils the refrigerant by transferring heat from the heat source HS. The condenser 220 condenses the refrigerant boiled by the boiler 210 and returns the boiled refrigerant to the boiler 210. The connector 260 is a connecting tube that connects the boiler 210 to the condenser 220 so that they communicate with each other. In the second embodiment, the boiler 210 and the condenser 220 are separated.

The boiler 210 includes the mount 11 and a reservoir 212 (see FIG. 21). The reservoir 212 accommodates the refrigerant that is in a liquid state. The reservoir 212 is defined by a recessed part 214a formed in a body 214 of the boiler 210 and the surface 11b of the mount 11. The reservoir 212 is provided as box-shaped space. The boiling surface portion 13 is in contact with the liquid refrigerant in the reservoir 212. Since the boiling surface portion 13 is similar to the first embodiment, it is formed by additive manufacturing but is not described in more detail here.

The condenser 220 is configured as a plate-fin type heat exchanger. The condenser 220 includes refrigerant flow-paths 221 and external flow-paths 222. The refrigerant flow-paths 221 and the external flow-paths 222 are alternately arranged by interposing a divider between the refrigerant and external flow-paths. The refrigerant flow-paths 221 are flow paths through which the refrigerant flows. The refrigerant flow-paths 221 communicate with the reservoir 212 of the boiler 10 through the connector 260. Corrugated fins are arranged to extend in the X direction inside the refrigerant flow-paths 221. The external flow-paths 222 are flow paths through which an external fluid flows. The external flow-paths 222 are opened toward the outside. Corrugated fins 222a are arranged to extend in the Y direction in the external flow-paths 222.

When the heat from the heat source HS is transferred to the boiling surface portion 13 through the mount 11, the liquid refrigerant in the reservoir 212 is heated and boiled. The refrigerant that is vaporized by boiling moves through the connector 260 into the refrigerant flow-paths 221, which communicate with the reservoir 212, and is cooled and condensed by the external fluid flowing through the external flow-paths 222. The refrigerant that is liquefied by condensation moves through the refrigerant flow-paths 221 and the connector 260, and returns to the reservoir 212. Accordingly, the refrigerant enclosed in the cooler 200 is circulated between the boiler 210 and the condenser 220. As a result, the heat source HS is cooled.

### (Boiling-Cooler Production Method)

A method for producing the cooler 200 according to the second embodiment is now described with reference to FIGS. 22 to 24.

As shown in FIG. 22, the method for producing the cooler 200 includes forming the boiler 210. The forming the boiler 210 includes forming the boiling surface portion 13, and joining the mount 11 to the body 214. Since forming the boiling surface portion 13 is similar to the first embodiment, the boiling surface portion 13 is at least partially formed by additive manufacturing but the forming the boiling surface portion is not described in more detail here.

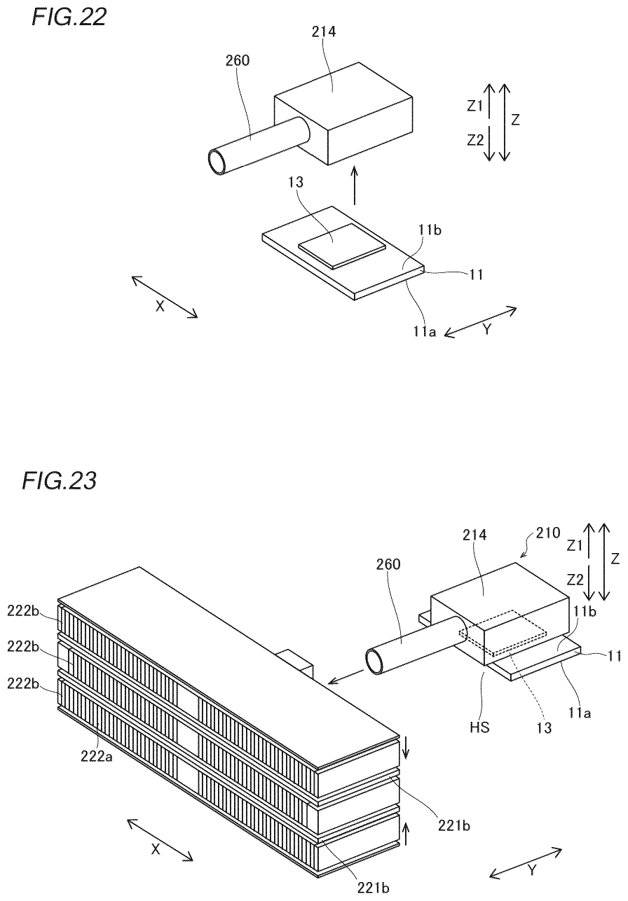

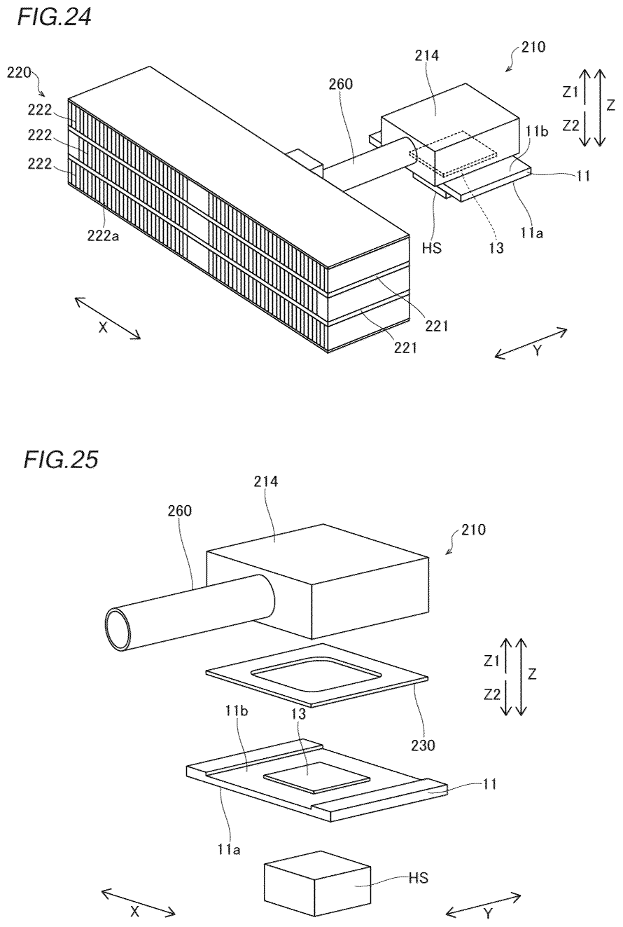

The joining the mount 11 onto the body 214 includes joining the mount 11 to the body 214 by welding. In this joining, four sides of the mount 11, which contact the body 214, are welded, for example. Also, the reservoir 212 is formed by joining the mount 11 onto the body 214 by welding. As a result, the boiler 210 is formed. As shown in FIG. 23, the method for producing the cooler 200 includes forming the condenser 220. The forming the condenser 220 includes forming the condenser 220 by joining refrigerant flow-path elements 221b, which will serve as the refrigerant flow-paths 221, to external flow-path elements 222b, which will serve as the external flow-paths 222. In addition, the method for producing the cooler 200 includes joining the boiler 210 to the condenser 220 through the connector 260. Accordingly, production of the cooler 200 is completed. After that, the heat source HS is mounted to the mounting surface 11a of the mount 11, as shown in FIG. 24.

The other configuration of the second embodiment is similar to the first embodiment.

### Advantages of Second Embodiment

In the method for producing the boiling cooler 200 according to the second embodiment, since the boiling surface portion 13 is formed on the surface 11b that is opposite to the mounting surface 11a onto which the heat source HS is mounted and is in contact with the refrigerant by using additive manufacturing, the boiling surface portion 13 having high boiling heat transfer performance can be obtained by simple processes similar to the first embodiment.

The other advantages of the second embodiment are similar to the first embodiment.

### First Modified Example of Second Embodiment

A cooler according to a first modified example of the second embodiment is now described with reference to FIG. 25. In the first modified example, the mount 11 is joined to the body 214 by brazing.

As shown in FIG. 25, the joining the mount 11 onto the body 214 includes joining the mount 11 to the body 214 by brazing. In this joining, a brazing sheet 230 including a core material and a brazing material on both sides of the core material is arranged between the body 214 and the mount 11. The mount 11 is brazed onto the body 214 by using the brazing sheet 230. The reservoir 212 is formed by brazing the mount 11 onto the body 214. As a result, the boiler 210 is formed, and production of the cooler 200 is completed. After that, the heat source HS is mounted to the mounting surface 11a of the mount 11.

### (Second Modified Example of Second Embodiment)

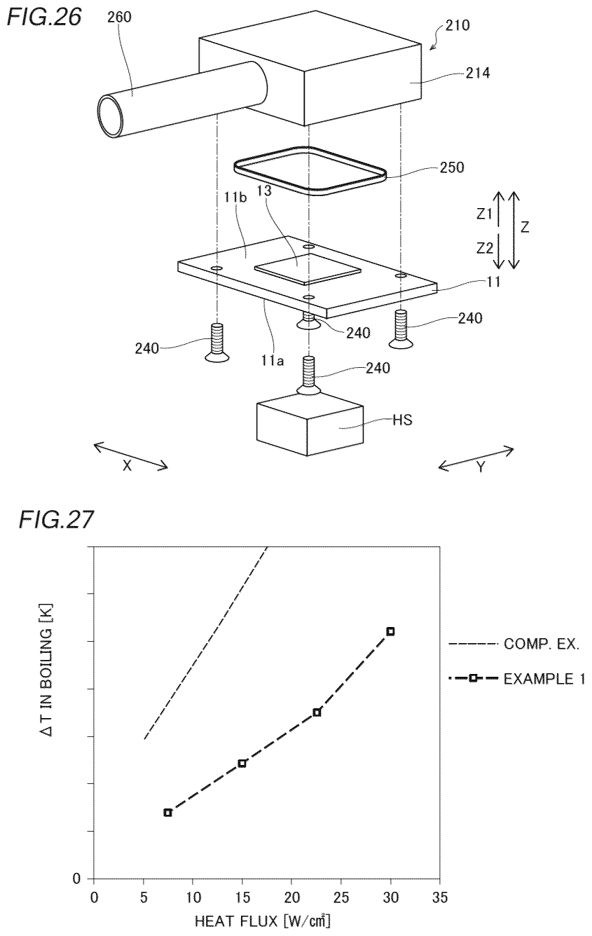

A cooler according to a second modified example of the second embodiment is now described with reference to FIG. 26. In the second modified example, the mount 11 is joined to the body 214 by screwing.

As shown in FIG. 26, the joining the mount 11 onto the body 214 includes joining the mount 11 to the body 214 by screwing. In this case, the mount 11 has insertion holes for receiving screws 240, and the body 214 has internally threaded holes with which the screws 240 threadedly engage. Also, a seal 250 such as an O-ring is arranged between the body 214 and the mount 11. The mount 11 is fixed onto the body 214 by screwing the screws 240 with the seal 250 being interposed between the body and the mount. As a result, the reservoir 212 is formed so that the boiler 210 is formed, and production of the cooler 200 is completed. Also, even in the case of screwing, the seal 250 can seal the refrigerant in the reservoir 212. After that, the heat source HS is mounted to the mounting surface 11a of the mount 11.

### EXAMPLES

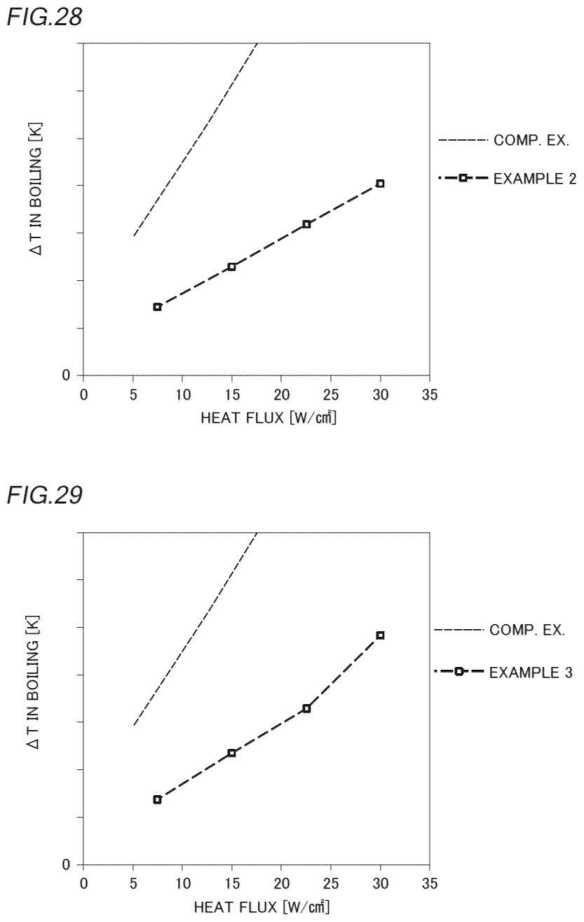

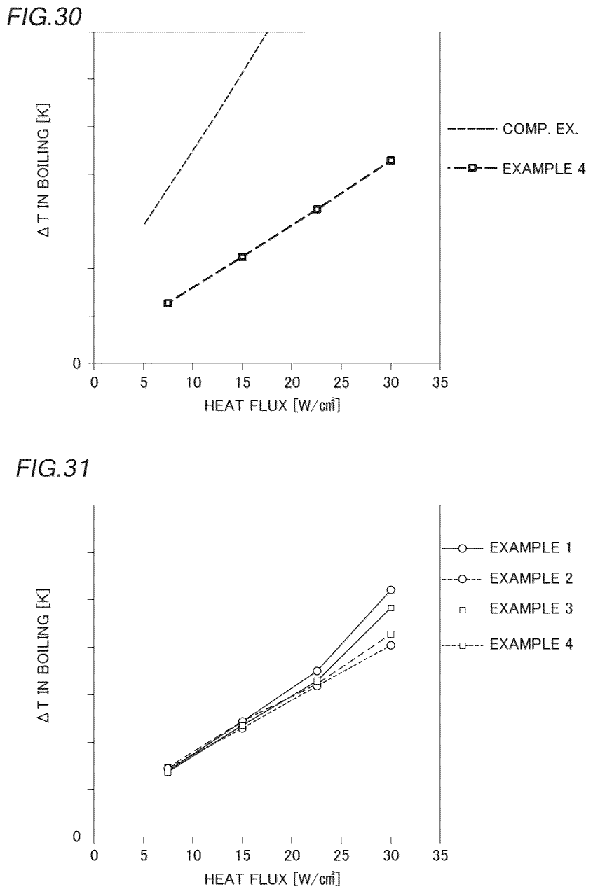

Measurement results of boiling heat transfer performance of the boiling surface portion are described with reference to FIGS. 27 to 31.

Coolers according to examples 1 to 4 as legends denoted in FIGS. 27 to 31 are test coolers including boiling surface portions formed in the shapes of the first to fourth examples, respectively, formed by additive manufacturing. Dimensions of protrusions, linear protrusions, and depressions in the boiling surface portions according to the examples 1 to 4 were set to values stated in the first embodiment. The boiling surface portions according to examples 1 to 4 were formed by powder bed fusion. A cooler of a comparative example was a test cooler including a boiling surface portion whose shape is similar to the first example formed by extrusion. Materials of the boiling surface portions according to the examples 1 to 4 and the comparative example were the same (aluminum). Hydrofluorocarbon was used as a refrigerant.

The boiling heat transfer performance of the coolers according to the examples 1 to 4 and the comparative example was measured under conditions in which they were heated by a test heat source. During the measurement, air was blown at a predetermined airflow rate to external flow-paths of their condensers. Refrigerant temperatures in their reservoirs and the maximum temperatures of their mounting surfaces were measured so that temperature differences ΔT between the refrigerant temperatures in the reservoirs and the maximum temperatures of the mounting surfaces were acquired as indices of boiling heat transfer performance. The smaller the temperature difference ΔT, the higher the heat transfer coefficient of boiling and the higher the boiling heat transfer performance (cooling performance) of the boiling surface portion. In addition, heat generation (heat flux) of the heat source was changed in steps so that the temperature difference ΔT was acquired at each heat flux.

FIGS. 27 to 30 are graphs showing the measurement results in the examples 1 to 4, respectively. FIG. 31 is a graph collectively showing the measurement results in the examples 1 to 4. In the graphs of FIGS. 27 to 31, horizontal axes represent the heat flux [W/cm²] of the heat source, and vertical axes represent the temperature difference ΔT [K].

It can be clearly seen from the graphs of FIGS. 27 to 30 that the temperature differences ΔT in the boiling surface portions according to the examples 1 to 4 were lower and their boiling heat transfer performance (cooling performance) was higher as compared with the conventional boiling surface portion of the comparative example formed not by additive manufacturing. Also, in comparison between the boiling surface portion according to the example 1 and the boiling surface portion according to the comparative example, although they had the same shape, the boiling heat transfer performance of the boiling surface portion according to the example 1 was higher. The reason can be presumed that boiling is accelerated by very small asperities formed on the surface of the boiling surface portion by additive manufacturing (powder bed fusion). Specifically, it can be presumed that very small asperities on the surface of the boiling surface portion serve as production points of bubbles (starting points of boiling) and increase the boiling heat transfer performance. From the measurement results, it is considered that a boiling surface portion having high boiling heat transfer performance can be provided by additive manufacturing.

It can be seen from the graph of FIG. 31, difference between the temperature differences ΔT in the boiling surface portions according to the examples 1 to 4 was small so that the boiling surface portions according to the examples 1 to 4 had similar boiling heat transfer performance in a low heat flux range. In contrast to this, in a high heat flux range, the temperature differences ΔT in the boiling surface portions according to the examples 2 to 4 were lower than the boiling surface portion according to the example 1 so that the boiling surface portions according to the examples 2 to 4 had higher boiling heat transfer performance (cooling performance). The reason can be presumed that the shapes of the boiling surface portions according to the examples 2 to 4 enhanced the boiling heat transfer performance in the high heat flux range.

In other words, it can be presumed that the boiling heat transfer performance was enhanced by alignment of the plurality of protrusions formed in shapes whose widths gradually increased from bases to ends of the protrusions in the examples 2 and 3. Specifically, the boiling surface portions according to the examples 2 and 3 were formed in the shapes defining the space, which was filled with the refrigerant, between the protrusions. Accordingly, it can be presumed that, when the refrigerant boiled on the protrusions or areas in proximity to protrusions, the refrigerant with which the space between the protrusions was filled was speedily supplied so that the protrusions and the areas in proximity to protrusions were unlikely to dry, which in turn increased the boiling heat transfer performance. Also, it can be presumed that the boiling heat transfer performance was enhanced by alignment of the plurality of depressions formed in shapes whose widths gradually increased from the openings in which bubbles are likely to be produced to the bottoms in the example 4. Also, it can be presumed that these shapes did not so sufficiently provide the enhancement in the low heat flux range so that the boiling surface portions according to the examples had similar boiling heat transfer performance in the low heat flux range. From the measurement results, it is considered that a boiling surface portion having higher boiling heat transfer performance can be provided according to the boiling surface portion that includes the plurality of protrusions formed in shapes whose widths gradually increase from the bases to the ends of the protrusions, and the boiling surface portion that includes the plurality of depressions formed in shapes whose widths gradually increase from the openings to the bottoms of the depressions.

Also, it can be seen from the graph of FIG. 31 that the temperature difference ΔT in the boiling surface portion according to the example 2 is lower so that the boiling heat transfer performance (cooling performance) in the example 2 is higher as compared with the boiling surface portion according to the example 3. The reason can be presumed that the refrigerant was more speedily supplied by the boiling surface portion according to the example 2, which included the protrusions without the linear protrusions, as compared with the boiling surface portion according to the example 3, which included both the linear and the protrusions. From the measurement results, it is considered that a boiling surface portion having higher boiling heat transfer performance can be provided according to the boiling surface portion including the plurality of protrusions without linear protrusions.

### Modified Embodiments

The boiling cooler may be a vertical-type boiling cooler including a vertical boiling surface portion. The boiling coolers according to the first and second embodiments are exemplary boiling coolers.

Also, the boiling surface portion may be formed by additive manufacturing other than powder bed fusion.

Also, the plurality of protrusions may be formed to be arranged in a staggered arrangement (zigzag arrangement) by additive manufacturing.

The protrusions may be formed to be aligned at a pitch not smaller than the width of each protrusion by additive manufacturing.

Also, the forming the boiling surface portion may include forming the boiling surface portion by additive manufacturing and then subjecting the boiling surface portion to blasting.

Also, the boiling surface portion including the plurality of protrusions formed in shapes whose widths gradually increase from the bases to the ends of the protrusions may be formed by machining, or a combination of machining and additive manufacturing.

The plurality of protrusions formed in shapes whose widths gradually increase from the bases to the ends of each protrusion may be formed in frustum shapes (e.g., prismoid other than regular quadrilateral prismoids, truncated cones, or the like) other than the regular quadrilateral prismoids.

Also, the boiling surface portion may be at least partially formed by additive manufacturing. For example, the boiling surface portion may be formed by forming protrusions by additive manufacturing on a bottom plate formed by technique other than additive manufacturing.

What is claimed is:

1. A method for producing a boiling cooler including a boiler for vaporizing a refrigerant by transferring heat from a heat source and a condenser for condensing the vaporized refrigerant and returning the condensed refrigerant to the boiler, the method comprising:
forming the condenser; and
forming the boiler, wherein
the forming the boiler includes forming a boiling surface portion on a surface that is opposite to a mounting surface onto which the heat source is mounted, and is in contact with the refrigerant, the mounting surface being a surface of a mount included by the boiler, and
the forming the boiling surface portion includes forming a plurality of protrusions whose widths gradually increase from bases to ends of the protrusions.

2. The method for producing the boiling cooler according to claim 1, wherein the forming the boiling surface portion includes at least partially forming the boiling surface portion by additive manufacturing using metal powder.

3. The method for producing the boiling cooler according to claim 2, wherein the forming the boiling surface portion includes at least partially forming the boiling surface portion by powder bed fusion as the additive manufacturing.

4. The method for producing the boiling cooler according to claim 1, wherein the forming the plurality of protrusions includes forming the plurality of protrusions to be aligned to each other in a matrix shape in first and second directions substantially perpendicular to each other in a plane substantially parallel to the boiling surface portion.

5. The method for producing the boiling cooler according to claim 1, wherein the forming the plurality of protrusions includes forming the plurality of protrusions to be aligned to each other in a staggered arrangement.

6. The method for producing the boiling cooler according to claim 1, wherein the forming the plurality of protrusions includes forming a plurality of linear protrusions that extend in a first direction in a plane substantially parallel to the boiling surface portion and aligned to each other in a second direction substantially perpendicular to the first direction in the plane substantially parallel to the boiling surface portion, and forming the plurality of protrusions that are aligned to each other on the linear protrusions and parts between the plurality of linear protrusions in the second direction.

7. The method for producing the boiling cooler according to claim 1, wherein the forming the plurality of protrusions includes forming the plurality of protrusions aligned at a pitch smaller than the width of each protrusion away from each other.

8. The method for producing the boiling cooler according to claim 1, wherein the forming the boiling surface portion includes forming the boiling surface portion without blasting after additive manufacturing.

9. The method for producing the boiling cooler according to claim 1, wherein the forming the boiling surface portion includes forming the boiling surface portion with blasting after additive manufacturing.

10. The method for producing the boiling cooler according to claim 1, wherein the forming the plurality of protrusions includes forming the plurality of protrusions into prismoid-shaped protrusions to be aligned to each other.

11. The method for producing the boiling cooler according to claim 1, wherein a distance between the ends of the protrusions adjacent to each other is smaller than the width of the end of one of the protrusions, and a distance between the bases of the protrusions adjacent to each other is greater than the width of the end of one of the protrusions.

12. The method for producing the boiling cooler according to claim 1, wherein the forming the boiling surface portion includes joining the condenser and the mount by welding, brazing, or screwing.

13. A boiling cooler comprising:
a boiler for vaporizing a refrigerant by transferring heat from a heat source; and
a condenser for condensing the vaporized refrigerant and returning the condensed refrigerant to the boiler, wherein
the boiler includes a mount, the mount including:
a mounting surface onto which the heat source is mounted; and
a boiling surface portion formed on a surface opposite to the mounting surface and is in contact with the refrigerant, and
the boiling surface portion includes a plurality of protrusions whose widths gradually increase from bases to ends of the protrusions.

14. The boiling cooler according to claim 13, wherein the plurality of protrusions are aligned in a matrix shape in the boiling surface portion in first and second directions substantially perpendicular to each other in a plane substantially parallel to the boiling surface portion.

15. The boiling cooler according to claim 13, wherein the plurality of protrusions are aligned to each other in a staggered arrangement.

16. The boiling cooler according to claim 13, wherein the boiling surface portion includes a plurality of linear protrusions that extend in a first direction in the plane substantially parallel to the boiling surface portion and aligned to each other in a second direction substantially perpendicular to the first direction in the plane substantially parallel to the boiling surface portion, and the plurality of protrusions that are aligned to each other on the linear protrusions and parts between the plurality of linear protrusions in the second direction.

17. The boiling cooler according to claim 13, wherein the plurality of protrusions are aligned at a pitch smaller than the width of each protrusion away from each other in the boiling surface portion.

18. The boiling cooler according to claim 13, wherein the protrusions are prismoid-shaped protrusions.

19. The boiling cooler according to claim 13, wherein a distance between the ends of the protrusions adjacent to each other is smaller than the width of the end of one of the protrusions, and a distance between the bases of the protrusions adjacent to each other is greater than the width of the end of one of the protrusions.

20. The boiling cooler according to claim 13, wherein the condenser and the mount are joined by welding, brazing, or screwing.
